(19) United States
(12) Patent Application Publication
(10) Pub. No.: US 2018/0155075 A1
(43) Pub. Date: Jun. 7, 2018

(54) TAGGING GUN AND METHOD AND SYSTEM TO USE RADIO FREQUENCY IDENTIFICATION TAGGING

(71) Applicant: WasteLess LTD, Kfar Saba (IL)

(72) Inventors: Oded Omer, Holon (IL); Ben Biron, Kfar Saba (IL); Yossi Regev, Ramat Gan (IL)

(73) Assignee: WasteLess LTD, Kfar Saba (IL)

(21) Appl. No.: 15/833,253

(22) Filed: Dec. 6, 2017

Related U.S. Application Data
(60) Provisional application No. 62/430,938, filed on Dec. 7, 2016.
(60) Provisional application No. 62/430,937, filed on Dec. 7, 2016.

(51) Int. Cl. B65C 11/00; G06K 7/10; B65C 9/00

(52) U.S. Cl. CPC B65C 11/004; G06K 7/10386; B65C 2210/0013; B65C 2009/0003; B65C 2201/00; B65C 9/0015

(57) ABSTRACT

Apparatuses and methods are provided for labeling a product and reading one or more labels. The apparatus includes an outer housing, a processing unit, wherein the processing unit includes a processor, a digital reader, coupled to the housing, wherein the digital reader is configured to extract information from one or more labels, one or more labels, and a label hatch configured to eject the one or more labels.

### CLAIM OF PRIORITY

This application claims priority to U.S. Provisional Patent Application No. 62/430,937, filed Dec. 6, 2016, and U.S. Provisional Patent Application No. 62/430,938, filed Dec. 7, 2016, herein incorporated by reference in their entirety.

### FIELD OF THE EMBODIMENTS

This invention relates to physical device, namely a radio frequency identification (RFID) stand-alone gun and barcode labeling gun assembly and more particularly, to an RFID/barcode gun that has a data entry module included and that is able to: read and transmit, in real time, one-by-one barcode labels that can include one or more of the following; 1.) Price data 2.) SKU name 3.) Expiration date; and burn in real time one-by-one RFID based labels that can include one or more of the following; 1.) Price data 2.) SKU name 3.) Expiration date. Expiration date herein can refer to any of the commonly used dates; 1.) Best used by 2.) Sell by 3.) Expired.

### BACKGROUND OF THE EMBODIMENTS

Food waste occurs everywhere and results in a major loss to human kind. Approximately 40 to 70 percent of the food grown is wasted and ends up in landfills. This is food that could have been used to feed those who are hungry. Furthermore, this is food that causes the manufacturers and sellers of the food to lose money. This is, thus, a problem in desperate need of a solution.

A system and/or method to aid in the reduction of food waste is thus needed.

Examples of related art are described below:

RFID guns can be found in markets, but those are far away from the suggested solution. The existing RFID guns are simply assemblies that hold RFID burner and sometimes also include monitoring display. They do not have any ability simultaneously create and erect RFID labels.

Chinese Patent Application No. CN101354740A generally describes a physical mobile assembly that has the capability to read and write RFID tags. The device is connected to remote terminal via Bluetooth connection. This is totally different from the patent suggested here.

U.S. Patent Publication No. 2013/0270341 generally describes systems, devices, and methods for generating a product label in which a price gun can comprise a barcode scanner configured to retrieve identification information from a label provided on a product having one or more individually-identifiable product characteristics, a communications module for communicating with a central database to retrieve product information associated with the product, and a label printer configured to selectively generate a product label containing the product information.

U.S. Pat. No. 5,726,431 generally describes a shelf tag printing system that includes a portable terminal in radio communication with a base station and a portable printer in wireless communication with the portable terminal. The portable terminal has a bar code scanner which reads product bar codes for radio transmission to the base station. The base station responds with informational signals indicating legends to be printed upon shelf tags by the printer. These signals are received by the portable terminal and relayed to the printer. Communication between the portable terminal and the printer is one-way via a surface wave acoustic resonator in the portable terminal and an amplifier sequenced hybrid receiver in the printer.

None of the art described above addresses all of the issues that the present invention does.

### SUMMARY OF THE EMBODIMENTS

According to an aspect of the present invention, an apparatus is provided for labeling a product and reading one or more labels. The apparatus includes an outer housing, a processing unit, wherein the processing unit includes a processor, a digital reader, coupled to the housing, wherein the digital reader is configured to extract information from one or more labels, one or more labels, and a label hatch configured to eject the one or more labels.

It is an object of the present invention to provide the apparatus for labeling the product and reading the one or more labels, wherein the one or more labels are radio frequency identification labels.

It is an object of the present invention to provide the apparatus for labeling the product and reading the one or more labels, wherein the apparatus further includes a radio frequency identification label writer configured to burn the one or more radio frequency identification labels with details pertaining to one or more products.

It is an object of the present invention to provide the apparatus for labeling the product and reading the one or more labels, wherein the one or more labels are barcode labels.

It is an object of the present invention to provide the apparatus for labeling the product and reading the one or more labels, wherein the apparatus further includes one or more secondary barcode readers configured to read the one or more barcode labels, in real time, as the one or more barcode labels are ejected.

It is an object of the present invention to provide the apparatus for labeling the product and reading the one or more labels, wherein the apparatus further includes a display configured to display information pertaining to one or more items.

It is an object of the present invention to provide the apparatus for labeling the product and reading the one or more labels, wherein the display further includes a graphical user interface.

It is an object of the present invention to provide the apparatus for labeling the product and reading the one or more labels, wherein the apparatus further includes a trigger configured to cause the label hatch to eject the one or inure labels.

According to another aspect of the present invention, a method is provided for labeling a product and reading one or more labels. The method includes inputting a product identification number from a label using an apparatus for labeling the product and reading the one or more labels, the apparatus including: an outer housing; a processing unit, wherein the processing unit includes a processor; a digital reader, coupled to the housing, wherein the digital reader is configured to extract information from one or more labels; one or more labels; and a label hatch configured to eject the one or more labels. The method further includes sending the product identification number to a server for analysis, determining, based on the analysis, an identification of the product, assigning one or more pieces of information to a label, and ejecting the label onto the product.

It is an object of the present invention to provide the method for labeling the product and reading the one or more labels, wherein the one or more pieces of information includes expiration information.

It is an object of the present invention to provide the method for labeling the product and reading the one or more labels, wherein the one or more labels are radio frequency identification labels.

It is an object of the present invention to provide the method for labeling the product and reading the one or more labels, wherein the method further includes burning the one or more radio frequency identification labels with details pertaining to one or more products using a radio frequency identification label writer.

It is an object of the present invention to provide the method for labeling the product and reading the one or more labels, wherein the one or more labels are barcode labels.

It is an object of the present invention to provide the method for labeling the product and reading the one or more labels, wherein the method further includes reading the one or more barcode labels, in real time, as the one or more barcode labels are ejected, using one or more secondary barcode readers.

It is an object of the present invention to provide the method for labeling the product and reading the one or more labels, wherein the method further includes displaying information pertaining to one or more items using a display coupled to the outer housing.

It is an object of the present invention to provide the method for labeling the product and reading the one or more labels, wherein the display further includes a graphical user interface.

It is an object of the present invention to provide the method for labeling the product and reading the one or more labels, wherein the ejecting further includes performing a predetermined action using a trigger.

### BRIEF DESCRIPTION OF THE DRAWINGS

FIG. 1 shows a front perspective view of a barcode and RFID label gun, according to an embodiment of the present invention.

FIG. 2 shows a rear perspective view of barcode and RFID label gun, according to an embodiment of the present invention.

FIG. 3 shows a front perspective view of a digital reader, according to an embodiment of the present invention.

FIG. 4 shows a rear perspective view of a digital reader, according to an embodiment of the present invention.

FIG. 5 shows a flow chart of a method for labeling and scanning one or more objects, according to an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

There are many methods to reduce food waste and this invention uniquely serves two major parts that are most important: 1.) It reduces the waste created by very confusing expiration dates reflected by manufacturers at on-premises retailers/wholesalers 2.) It improves food waste tracking and analytics. This patent application discusses this new approach that can be used together with existing retail systems such as electronic price tags and legacy point of sale systems.

According to an embodiment, the present system includes an upgraded price gun that includes a processing unit with a small touch screen and a set of read/write units used to detect a product barcode and/or RFID label, assign expiry date to the product and then either “read” the data of the barcode before ejecting it simultaneously by the gun, or “burn” the data into an RFID tag before erecting it simultaneously by the gun. Following successful erection of the barcode and/or the RFID label, the barcode and/or the RFID label on the product will carry at least product's name and expiry date, as well as carry further meta data. According to an embodiment, the gun assembly will send its activity data to one or more secondary devices and/or servers. According to an embodiment, the data may be sent over a wired and/or wireless connection. According to an embodiment, the data includes the amount of stock keeping units (SKUs) that were written and relevant expiry date for each SKU.

According to an embodiment, the assembly presented is based on a novel approach to use a combination of price tags gun, barcode and/or RFID label reader/writer, computing capabilities and wired and/or wireless communication in order to read/write and eject simultaneously pre-printed barcode labels and/or RFID labels that contain expiry dates along with other meta data that is related to the product, such as, e.g., SKU name, barcode value, and internal prefix/suffix for further tracking. The advance tagging will result in a capability to control pricing (Dynamic Pricing) in order to reduce global on premise food-waste. According to an embodiment, the assembly may be used by wholesaler or supermarket personnel. It is noted, however, that the present assembly may be configured to be used by any suitable user dealing with barcodes and/or RFID labels.

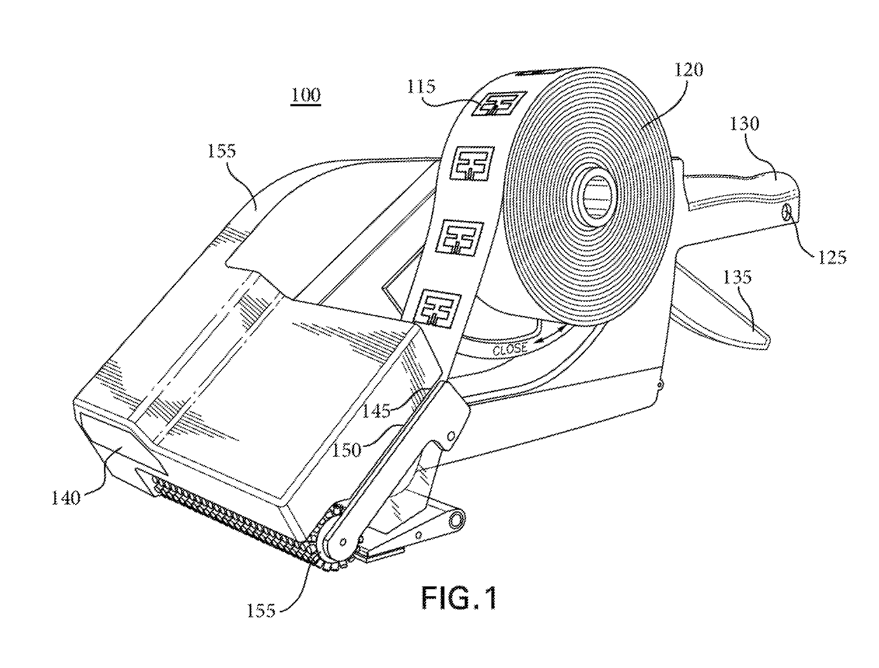

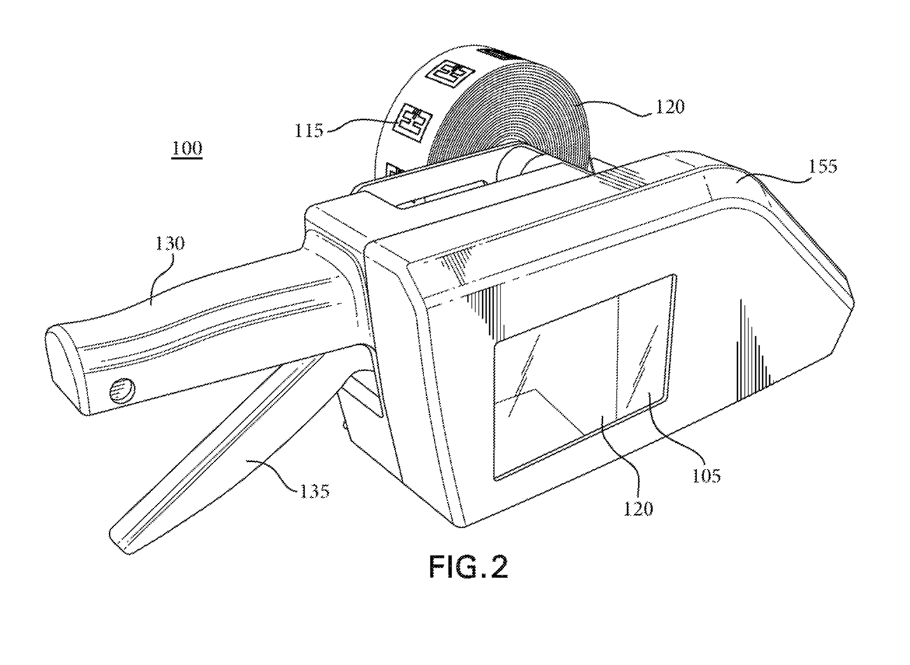

Referring now to FIGS. 1-2, a front perspective view (FIG. 1) and a rear perspective view (FIG. 2) of a barcode and RFID label gun 100 are illustratively depicted, in accordance with an embodiment of the present invention.

According to an embodiment, the barcode and RFID label gun 100 includes a processing unit 105 (which may include a processor and/or a memory), a display 110, a label roll 120 containing one or more barcodes and/or RFID labels 115, a charging socket 125, a gun handle 130 and trigger 135, a digital reader 140, an RFID writer 150, and a label hatch 155.

The processing unit 105 and display 110 can be based on a microcontroller or any other suitable type of computer that carries an operating system (OS). According to an embodiment, the display 110 include a graphical user interface such as, e.g., a touch screen. According to an embodiment, the processing unit 105 is responsible for any software needed for the system 100 to operate properly. It should enable the user at least to be able to scan an SKU barcode, set an expiry date (Using the attached touch screen), read and eject simultaneously barcode labels 115 (One-by-one) and/or write and erect simultaneously RFID labels 115 (One-by-one), and, lastly, send all the data to a backend server.

According to an embodiment, the barcode and RFID gun assembly 100 operates on battery for best user experience and hence should be charged from time to time. Accordingly, charging socket 125 is used in order to connect the assembly 100 to the power grid. According to an embodiment, the barcode and RFID gun assembly 100 includes a removable battery, enabling a user to replace the battery.

According to an embodiment, the action trigger 135, when squeezed, causes the barcode and RFID gun to read and ejects a barcode label 115 that carries all the relevant information, or writes and erects an RFID label 115 that carries all the relevant information.

According to an embodiment, the digital reader 140 is coupled to the processing unit 105 and is configured to enable the user to retrieve relevant SKU information from one or more remote servers. According to an embodiment, the digital reader 140 is configured to read a barcode and/or an RFID label 115. According to an embodiment, after reading a barcode and/or an RFID label 115, relevant information appears on the device's 100 display 110. According to an embodiment, relevant information may include product name, product list price, and/or any other relevant information.

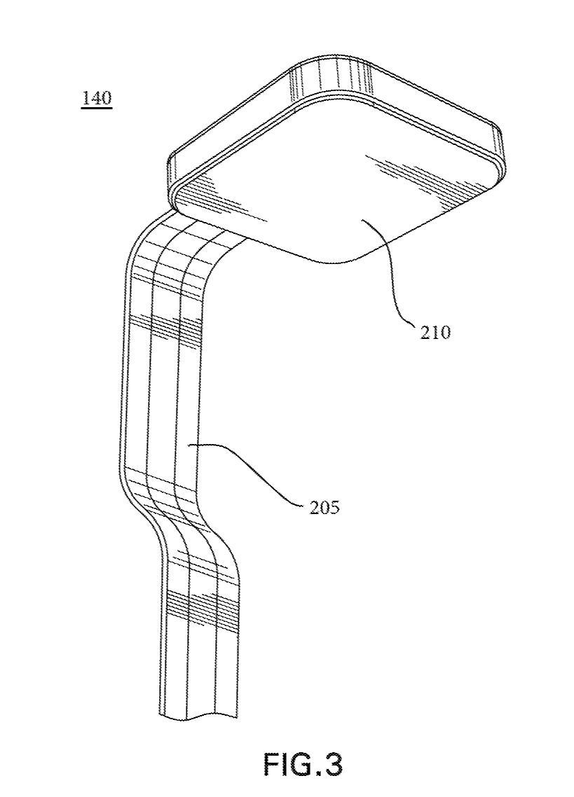

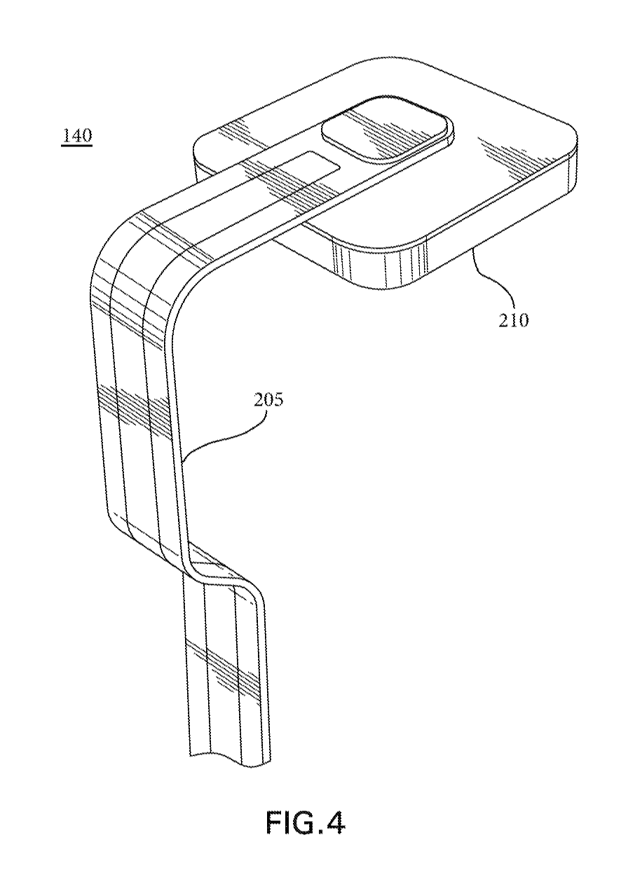

According to an embodiment, the digital reader 140 is a separate structure, separate and apart from the gun 100 (as shown in FIGS. 3-4). The digital reader 140 shown in FIGS. 3-4 has a neck 205 leading up to a scanning surface 210. It is noted, however, that the digital reader 140 may include any suitable design and/or shape. According to an embodiment, the digital reader 140 may be used during the purchase of one or more tagged goods. It is noted, however, that the digital reader 140 may be used for any suitable function such as, e.g., acquiring relevant information about the goods which are tagged.

According to an embodiment, the system 100 includes a secondary barcode scanner 145. According to an embodiment, the secondary barcode scanner 145 is coupled to the processing unit 105 and is configured to read the barcode label 115, in real time, as the barcode label 115 is ejected.

According to an embodiment, the RFID writer 150 is configured to burn the RFID label with details that are displayed on the display 110.

According to an embodiment, the label hatch 155 is configured to eject a single label 115 whenever a user performs a designated action. According to an embodiment, the designated action is the squeezing of the trigger 135 against the handle 130. According to an embodiment, the label 115 is a barcode and/or an RFID label. According to an embodiment, the labels 115 are positioned on the label roll 120. According to an embodiment, the label roll 120 is configured to be fed into the gun 100 in order to support continuous one-after-one label 115 ejection.

According to an embodiment, the system 100 further includes a gun chasses 155 configured to hold all parts together. According to an embodiment, the gun chassis 155 includes a polymer and/or any other suitable plastic material, a metal, and/or any other suitable material.

This assembly 100 plays part in a wider system that enables a global reduction of food waste in supermarkets and wholesalers. It is based on case studies prove that food products that have dynamic pricing sell more. By including readable expiry date on a food package along with other information and in conjunction with multiple-feeds dynamic pricing engine, this assembly can majorly impact consumption patterns and reduce global food-waste.

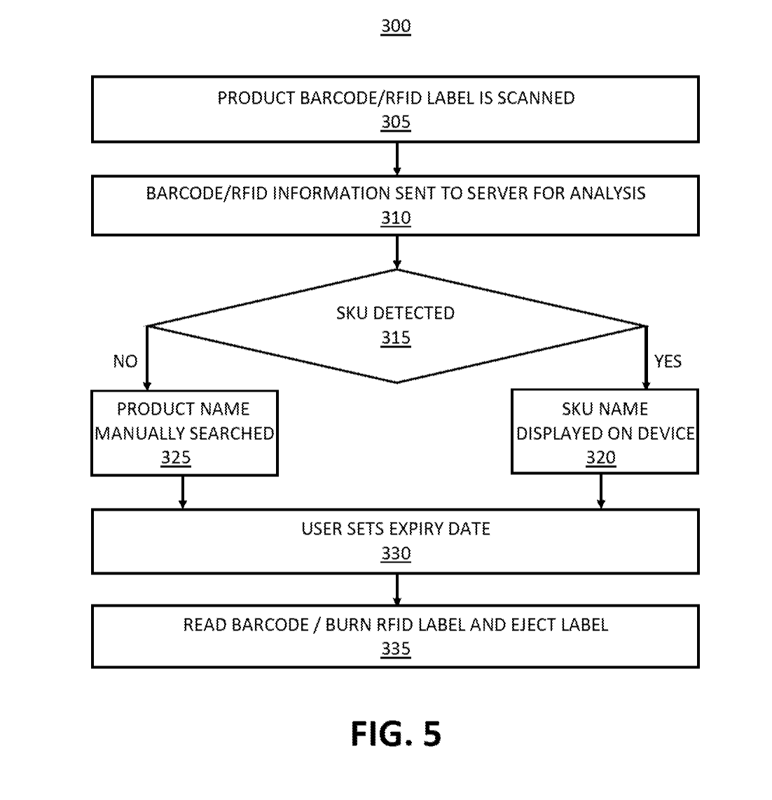

Referring now to FIG. 5, a method 300 for labeling one or more products and reading one or more labels, in accordance with an embodiment of the present invention.

At step 305, a product's barcode and/or RFID tag 115 is scanned using the digital reader 140. According to an embodiment, the barcode number (or other identifiable information) may be manually inputted, using the graphical user interface on the display 110. Whether input or scanned, the barcode number (or other identification information), at step 310, is sent to a local and/or remote server. The server may be a cloud based server, a local server, and/or any other suitable server.

Once sent to the local and/or remote server, it is determined, at step 315, whether any SKU number was detected. If a SKU number is detected, then, at step 320, the SKU name is presented on the display 110. If a SKU number is not detected, then, at step 325, the user may select the product name from a list.

Once the product name is determined, then, at step 330, the user selects an expiry date. In order to create an RFID label 115 that contains all of the information needed for food-waste reduction and waste analysis, the user sets the expiry date for the products that are about to be tagged. In order to assign barcode label with expiration date, the user sets expiry date for the products that are about to be tagged. According to an embodiment, the selection of expiry date is done using graphical user interface of the display 110.

At step 335, one or more products are tagged. According to an embodiment, the tagging occurs when the user squeezes the gun assembly in order to attach RFID labels simultaneously one-after-one. According to an embodiment, the tagging occurs when the user squeezes the gun assembly in order to eject barcode labels simultaneously one-after-one. According to an embodiment, each label includes the relevant information that is related to the product.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. An apparatus for labeling a product and reading one or more labels, comprising:
an outer housing;
a processing unit,
wherein the processing unit includes a processor;
a digital reader, coupled to the housing,
wherein the digital reader is configured to extract information from one or more labels;
one or more labels; and
a label hatch configured to eject the one or more labels.

2. The apparatus as recited in claim 1, wherein the one or more labels are radio frequency identification labels.

3. The apparatus as recited in claim 2, further comprising a radio frequency identification label writer configured to burn the one or more radio frequency identification labels with details pertaining to one or more products.

4. The apparatus as recited in claim 1, wherein the one or more labels are barcode labels.

5. The apparatus as recited in claim 4, further comprising one or more secondary barcode readers configured to read the one or more barcode labels, in real time, as the one or more barcode labels are ejected.

6. The apparatus as recited in claim 1, further comprising a display configured to display information pertaining to one or more items.

7. The apparatus as recited in claim 6, wherein the display further includes a graphical user interface.

8. The apparatus as recited in claim 1, further comprising a trigger configured to cause the label hatch to eject the one or more labels.

9. A method for labeling a product and reading one or more labels, comprising:
inputting a product identification number from a label using an apparatus for labeling the product and reading the one or more labels, the apparatus including:
an outer housing;
a processing unit,
wherein the processing unit includes a processor;
a digital reader, coupled to the housing,
wherein the digital reader is configured to extract information from one or more labels;
one or more labels; and
a label hatch configured to eject the one or more labels; sending the product identification number to a server for analysis;
determining, based on the analysis, an identification of the product;
assigning one or more pieces of information to a label; and
ejecting the label onto the product.

10. The method as recited in claim 9, wherein the one or more pieces of information includes expiration information.

11. The method as recited in claim 9, wherein the one or more labels are radio frequency identification labels.

12. The method as recited in claim 11, further comprising burning the one or more radio frequency identification labels with details pertaining to one or more products using a radio frequency identification label writer.

13. The method as recited in claim 9, wherein the one or more labels are barcode labels.

14. The method as recited in claim 13, further comprising reading the one or more barcode labels, in real time, as the one or more barcode labels are ejected, using one or more secondary barcode readers.

15. The method as recited in claim 9, further comprising displaying information pertaining to one or more items using a display coupled to the outer housing.

16. The method as recited in claim 15, wherein the display further includes a graphical user interface.

17. The method as recited in claim 9, wherein the ejecting further includes performing a predetermined action using a trigger.
